(19) United States
(12) Patent Application Publication
(10) Pub. No.: US 2026/0266354 A1
(43) Pub. Date: Sep. 10, 2026

(54) CLAMPING DEVICE AND CLAMP

(71) Applicant: GRIPPLE LIMITED, Sheffield, South Yorkshire (GB)

(72) Inventor: Thomas Reynolds, Sheffield, South Yorkshire (GB)

(21) Appl. No.: 18/871,735

(22) PCT Filed: Jun. 2, 2023
(86) PCT No.: PCT/IB2023/055688

§ 371 Date: Dec. 4, 2024

(30) Foreign Application Priority Data
Jun. 7, 2022 (GB) 2208293.7
Jun. 1, 2023 (GB) 2308200.1

(51) Int. Cl. F16G 11/10; E04H 17/04

(52) U.S. Cl. CPC F16G 11/106; E04H 17/045

(57) ABSTRACT

Aspects relate to a clamping device (100) and a clamp (200). The clamp (200) is for securing an elongate article (1), such as barbed wire, within the clamping device (100). The clamp (200) comprises an elongate clamp body (202) having opposite ends (208, 210). The clamp (200) comprises a clamping surface (206) on the clamp body (202). The clamp (200) comprises a sliding surface (212) on the clamp body (202). The clamping surface (206) is substantially parallel to the sliding surface (212).

### FIELD OF THE INVENTION

Embodiments of the present invention relate to a clamping device and a clamp. In particular, but not exclusively they relate to a barbed wire clamping device and a barbed wire clamp.

### BACKGROUND TO THE INVENTION

Some wires comprise twisted (helically wound) strands. The twisted strands define a minor diameter and a larger major diameter. When viewed from the side, the wire will appear to have a scalloped/undulating surface comprising a plurality of troughs (the minor diameter) and separated by peaks (the major diameter). Barbed wire is one such example.

When installing a wire fence, such as a barbed wire fence, it would be desirable to efficiently connect barbed wire ends together to form a continuous length. A connector can be provided for this purpose. It would be desirable for such connectors to offer a high resistance to pullout loads, while being easy and quick to install/release, without the connectors being bulky or inefficient to manufacture.

### BRIEF DESCRIPTION OF VARIOUS EMBODIMENTS OF THE INVENTION

According to an aspect of the invention there is provided a clamp for securing an elongate article within a clamping device, the clamp comprising:
an elongate clamp body having opposite ends;
a clamping surface on the clamp body; and
a sliding surface on the clamp body, wherein the clamping surface is substantially parallel to the sliding surface.

An advantage is improved biting force, also referred to as join efficiency. This is because the clamping surface can be slid into a trough/valley defining the minor diameter of a twisted elongate article such as barbed wire. The join efficiency is better than a wedge-shaped clamp of the same size, because wedge-shaped clamps rest on the major-diameter peaks of the elongate article. By allowing the clamp to rest in the minor-diameter troughs of a double-helical wire, the clamp can lock itself in place and prevent slip on the wire. This also adds a greater benefit because the clamp can ‘bite’ onto both strands of the barbed wire, which is something roller clamps are not always able to do. Also, a typical wedge-shaped clamp would need to be two to three times longer to grab the full double-helix, which would result in a much larger product.

The term ‘substantially parallel’ has a tolerance associated therewith. The tolerance may be 5 degrees or the tolerance may be 1 degree.

The clamping surface may be ‘substantially parallel’ in the sense that a plane defined by the clamping surface is substantially parallel to a plane defined by the sliding surface. The clamping surface and sliding surface may be substantially flat surfaces.

The opposite ends of the clamp body may be opposite first and second ends. In use, the clamp may be urged into engagement with the elongate article in a direction in which the first end leads the second end. The opposite ends may be leading and trailing ends.

The trailing end of the clamp body may comprise an approximately flat rear surface connecting the sliding surface to the clamping surface. The rear surface is sufficiently flat to enable a spring to be seated against the trailing end of the clamp body. In use, the spring slides the clamp towards the side of the elongate article.

Additionally, or alternatively, the trailing end may comprise a protruding spring seat. The spring seat may protrude in a trailing direction.

The trailing end of the clamp body may be at an obtuse angle relative to the sliding surface of the clamp. The obtuse angle may be selected from the range greater than 90 degrees to less than 110 degrees, to help seat the spring onto the clamp and resist buckling.

The clamp body may be shaped such that the leading end of the clamp body leads a leading end of the clamping surface. The clamp body may further comprise an inwardly tapering portion, separate from the substantially parallel sliding surface and clamping surface. The inwardly tapering portion may be wedge-shaped. The inwardly tapering portion may extend from the leading edge of the clamping surface to the leading end of the clamp body. The inwardly tapering portion may comprise a tapering surface connected to the leading edge of the clamping surface. The tapering surface may converge towards the sliding surface. The tapering surface may be smoother than the clamping surface.

An advantage of the inwardly tapering portion is that the elongate article is easier to feed through the clamping device in a feed direction.

The inwardly tapering portion may extend from a first serration (leading serration) defining the leading end of the clamping surface, to the leading end of the clamp body. A rate of tapering of the inwardly tapering portion may comprise curvature towards the leading end of the clamp body. Alternatively, a straight taper may be used.

An internal angle between the inwardly tapering portion of the clamp and a plane defined by the clamping surface of the clamp, measured at the leading edge of the clamping surface, may be an obtuse angle. This V-shaped internal angle approximately matches the V-shape of the minor-diameter trough (V-shaped when the elongate article 1 is viewed from the side). This defines the rate or starting rate of tapering of the inwardly tapering portion. The obtuse angle may be a value of at least 310 degrees (130-degree internal angle). The obtuse angle may be a value of less than approximately 350 degrees (170-degree internal angle).

An advantage is enabling the leading edge of the clamping surface to fully embed into a minor-diameter trough in the side of most types of barbed wire.

The clamping surface of the clamp may be serrated. The clamping surface may comprise a plurality of serrations, each for engaging the elongate article. The plurality of serrations may be a plurality of parallel serrations, such as more than five parallel serrations.

The serrations may be sawtooth-shaped, to prevent the elongate article from slipping in a given direction.

Depths of the serrations may vary along the clamping surface. The serrations towards the trailing end of the clamp body may be deeper than serrations towards the leading end of the clamp body. An advantage is improved join efficiency. This is because overly-aggressive leading serrations were found to create a less uniform break in the elongate article. The leading serrations may be configured to initiate the break in the elongate article when overloaded, wherein the break could occur at lower loads if the leading serrations were to be deeper. The deeper trailing serrations at the trailing end of the clamp also help to lock the clamp into the minor-diameter trough and pull the clamp into the wire.

The clamping surface may have a length greater than 2 mm and in the order of 10\hat{ }0 mm. The clamping surface may have a width greater than 2 mm and in the order of 10\hat{ }0 mm. This sizing is suitable for most barbed wire and enables the clamping device to be small enough to fit between adjacent spaced barbs of the barbed wire.

The clamp body may comprise a runner arrangement configured to be constrained in-use by a track arrangement of the housing of the clamping device to constrain one or more degrees of freedom of translation of the clamp as the clamp is slid towards and away from the elongate article at an oblique angle. The runner arrangement may be substantially parallel to the sliding surface and the clamping surface.

An advantage is that the clamp is maintained in a stable orientation which makes it easier to release.

An advantage of the track and runner arrangements is that during release of the elongate article, the clamp can be reliably moved clear of the passage. This lowers resistance to removal of the elongate article, and avoids abrasion of the clamping surface of the clamp as the elongate article is drawn through the passage.

The runner arrangement of the clamp body may comprise a step in a left side of the clamp body. Additionally, or alternatively, the runner arrangement of the clamp body may comprise a step in a right side of the clamp body. The step or steps may cause the clamping surface to be narrower than the sliding surface. The step or steps are configured to engage with the track arrangement of the housing of the clamping device.

According to another aspect of the invention there is provided a clamping device comprising:
a housing comprising apertures to allow an elongate article to extend through a passage within a space in the housing of the clamping device; and
the clamp as described in any one or more of the preceding statements.

According to a further aspect of the invention there is provided a clamping device comprising:
a housing comprising apertures to allow an elongate article to extend through a passage within a space in the housing of the clamping device; and
a clamp comprising an elongate clamp body having opposite ends, and a clamping surface on the clamp body,
wherein the housing of the clamping device comprises a first clamping formation against which the clamp is configured to clamp the elongate article,
wherein the clamp is movable in the housing to a clamping position in which the clamp wedges the elongate article against the first clamping formation of the housing of the clamping device, at an angle in which the clamping surface of the clamp body is at an oblique angle relative to the first clamping formation of the housing.

This enables the clamp to embed into a minor-diameter trough in the side of a twisted elongate article. The clamp may be as described in any one or more of the preceding statements. Alternatively, the clamp may have a different shape.

The first clamping formation may be a first clamping wall, which may extend along the passage. The first clamping formation may be a substantially flat wall. An advantage of a flat wall compared to a grooved wall, according to experiments, is that the elongate article is easier to load and the join efficiency is improved.

The housing of the clamping device may comprise a second clamping wall for applying a clamping force to the clamp. Thus, the clamp and the elongate article can be clamped between the first and second clamping walls. The second clamping wall may be a second clamping wall.

The first and second clamping walls may converge towards each other. The first and second clamping walls may provide a narrowing gap therebetween. The first and second clamping walls may be tapered inwardly.

The clamping surface of the clamp body may be approximately parallel to the second clamping wall.

The clamp body of the clamp may comprise a sliding surface. The sliding surface may be approximately parallel to the second clamping wall. The sliding surface of the clamp body may be configured to slide along the second clamping wall. The sliding surface may be as described in any one or more of the preceding statements. The sliding surface may be substantially parallel to the clamping surface of the clamp body.

The second clamping wall may comprise a plurality of parallel running ribs along which the sliding surface of the clamp body can slide, and/or the sliding surface of the clamp body may comprise a plurality of parallel running ribs configured to act as sliding rails. Either way, the effect is that the area of engagement between the clamp and the second clamping wall is reduced. The advantage is that the clamp can slide with greater ease and reduce the risk of friction buildup, which can affect biting force.

The housing may comprise a track arrangement to guide movement of the clamp relative to the passage. The track arrangement may be as described in any of the preceding statements. The track arrangement may be angled towards the passage at an oblique angle.

The oblique angle may be a value selected from the range 7 degrees to less than 30 degrees. A lower value of the oblique angle enables higher clamping force, whereas a steeper angle enables easier insertion of the elongate article in the feed direction. An optimum subrange is from approximately 10 degrees to less than 20 degrees.

In a specific example, the track arrangement may comprise side ledges to engage with the earlier-described steps of the clamp body and seat the clamp body within the track arrangement. As the clamp is moved, the steps of the clamp body may slide along the side ledges.

The narrower clamping surface of the clamp may protrude towards the passage beyond the track arrangement. This prevents serrations on the clamping surface from binding on the housing.

The track arrangement may be parallel to the above-described second clamping wall. The sliding surface may be configured to slide along the second clamping wall as the clamp is slid along the track arrangement. The sliding surface of the clamp body may remain approximately parallel to the second clamping wall regardless of the position of the clamp along the track arrangement. Therefore, the clamping surface of the clamp body may remain approximately parallel (within three degrees) to the second clamping wall regardless of the position of the clamp along the track arrangement.

The clamping device may comprise a spring for urging the clamp. The spring may be as described in any of the preceding statements. The spring may urge the clamp into clamping engagement with the elongate article. The spring may comprise a coil spring. The spring may be a compression spring. However, it will be appreciated that the spring could be any other suitable urging member.

The spring may urge the clamp towards an entrance aperture of the apertures of the housing of the clamping device. The spring may urge the clamp into the narrowing gap between the first and second clamping walls. The direction of the spring may be approximately parallel to the second clamping wall. The direction of the spring may be approximately parallel to the track arrangement. Therefore, the spring is able to slide the clamp along the track arrangement in a clamping direction towards the passage.

The clamping device may comprise a spring seat for applying a reaction force to the spring. The spring seat may extend partially across one end of the passage. The spring seat may extend partially across an exit end of the space. The spring seat may be alongside an exit aperture of the apertures of the housing of the clamping device.

The apertures of the housing of the clamping device may be opposite apertures. The passage may be a substantially straight, linear passage between the opposite apertures. The first clamping wall may be a substantially straight, linear wall between the opposite apertures.

To slide the clamp away from the passage, the user may insert a thin object through the entrance aperture to push the clamp and release the elongate article. Alternatively, a dedicated release aperture or a release button may be provided, adjacent the entrance aperture.

The housing of the clamping device may comprise a second one of each clamping-related feature described above (second opposite apertures, second passage, second space, second track arrangement, second clamp, etc.) to enable a further elongate article portion to be clamped. They may function in the same manner as described above. The second clamp may apply clamping force in an opposite direction than the first clamp. The spaces may be partitioned, each side of the partition representing a first clamping wall of the corresponding passage.

An advantage is that the clamping device can secure two wires end-to-end, for example. The clamping device can therefore be used at spaced intervals when installing barbed wire fencing.

### BRIEF DESCRIPTION OF THE DRAWINGS

For a better understanding of various examples of embodiments of the present invention reference will now be made by way of example only to the accompanying drawings in which:

FIG. 1 illustrates a perspective view of an example clamping device;

FIG. 2 illustrates a side cross-section of the clamping device;

FIG. 3 illustrates an end cross-section of the clamping device;

FIG. 4 illustrates a perspective view of an example clamp; and

FIG. 5 illustrates a side cross-section view of a clamping device and barbed wire.

### DETAILED DESCRIPTION OF VARIOUS EMBODIMENTS OF THE INVENTION

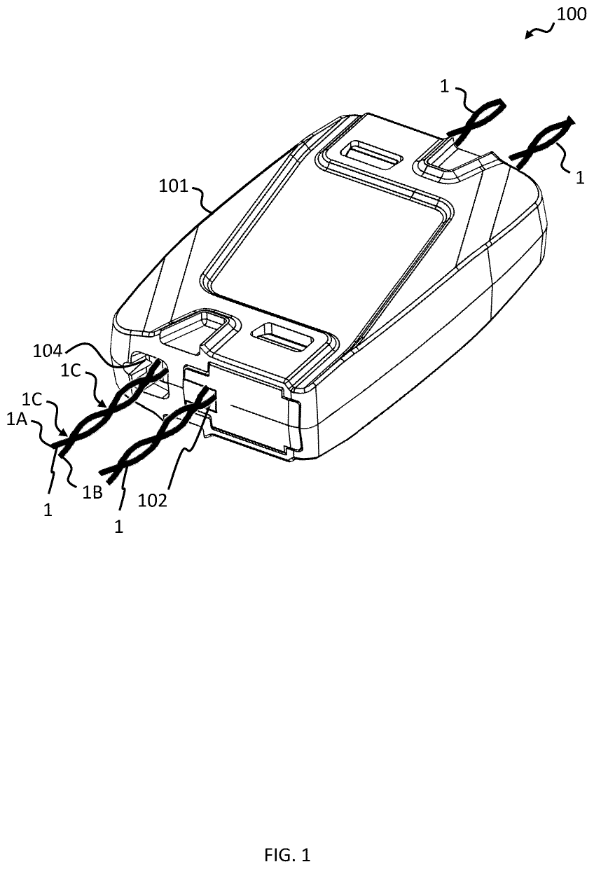

FIG. 1 illustrates an example clamping device 100 for clamping an elongate article 1 (shown in broken lines in FIG. 1). The elongate article 1 may be in the form of a twisted wire such as barbed wire. As shown in FIG. 5, the barbed wire comprises a first strand 1A and a second strand 1B twisted to define a plurality of minor-diameter troughs 1C (lays).

As shown in the Figures, the clamping device 100 comprises a housing 101 having apertures 102, 104, and internal components within the housing 101. The internal components include one or more clamps 200. Each clamp 200 is an effector for engaging with an elongate article 1.

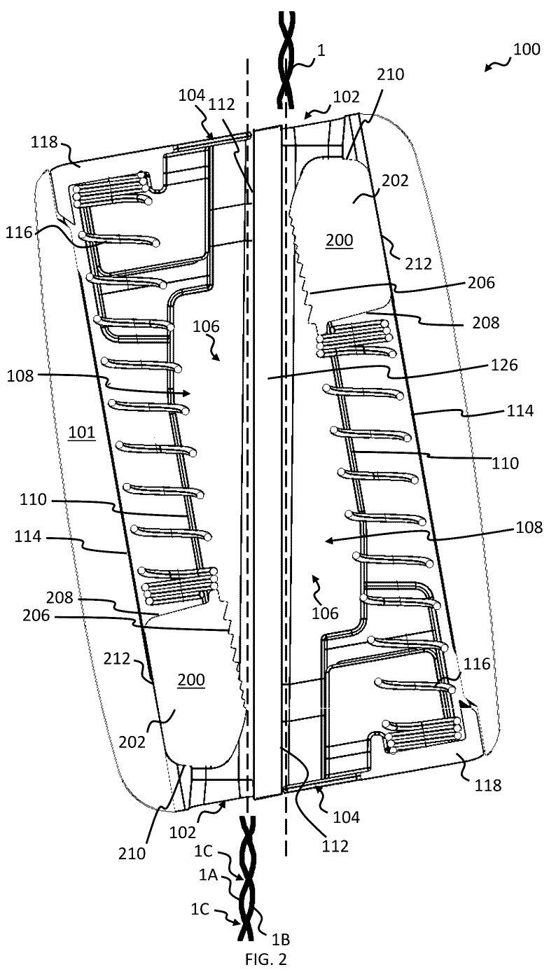

As shown in FIGS. 2-4, each clamp 200 consists of an elongate clamp body 202. The clamp 200 (/clamp body 202) is movable within the clamping device 100. The clamp 200 is not limited to the specific shape and configuration shown.

The clamp 200 has a leading end 210 and an opposite, trailing end 208. In use, the clamp 200 can be urged into engagement with the elongate article 1 in a direction in which the leading end 210 leads the trailing end 208. The clamp 200 comprises an elongate clamping surface 206 extending therebetween. The clamping surface 206 has a plurality of parallel serrations 218 to provide tight engagement with the elongate article 1. As shown, the serrations 218 may extend perpendicular to the axis of the elongate article 1.

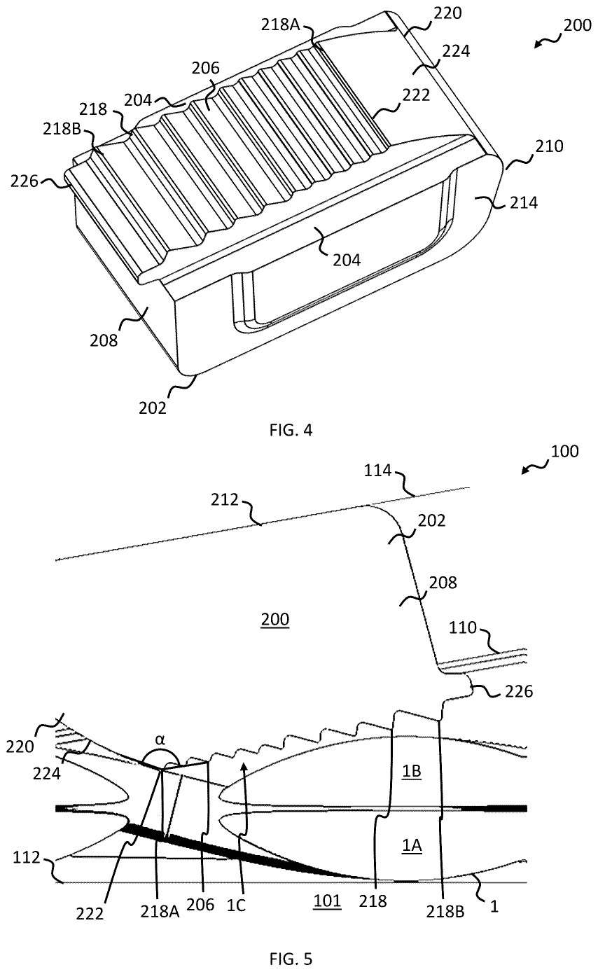

FIGS. 4 and 5 illustrate the plurality of serrations 218 including a first, leading serration 218A proximal to the leading end 210, and a last, trailing serration 218B proximal to the trailing end 208. The illustrated clamp 200 comprises ten parallel serrations 218, by way of example. The apex of the leading serration 218A may define a leading edge 222 of the clamping surface 206.

From FIG. 5, it can be seen that the depths of the serrations may vary along the clamping surface. The serrations towards the trailing end 208 of the clamp 200 are deeper than serrations towards the leading end 210 of the clamp 200. The leading serration 218A is shallower than the trailing serration 218B.

The opposite surface of the clamp 200, opposite the clamping surface 206, is an elongate sliding surface 212 for sliding against an internal wall 114 of the clamping device 100. The clamp 200 has left and right sides 214, 216 (side surfaces) interconnecting the clamping surface 206 and the sliding surface 212.

In an example implementation, the clamping surface 206 has a length from the range 5-10 mm, defined as the distance from the apex of the leading serration 218A to the apex of the trailing serration 218B. The clamping surface 206 has a width from the range 2-7 mm. This sizing is suitable for most barbed wire.

Regarding materials, the clamp 200 may be formed of a ceramic or metal material. The housing 101 may be formed of a metal material. It would be appreciated that other materials could be used.

As shown in FIGS. 2 and 5, the clamping surface 206 and the sliding surface 212 may be substantially parallel to each other. For example, the apexes of the serrations 218 may define a plane which is substantially parallel to the plane of the smoother, flat clamping surface 206.

As shown in FIG. 2, a spring 116 wedges the clamp 200 into a small area of the internal space 108 within the clamping device 100 so that the clamping surface 206 of the clamp 200 is biased into a minor-diameter trough 1C between the helical strands 1A, 1B of an inserted elongate article 1.

To insert an elongate article 1, the elongate article 1 can be fed through the clamping device 100 in a predetermined feed direction. This is not resisted by the clamp 200. However, the clamp 200 prevents the elongate article 1 from slipping in the reverse direction.

Insertion of the elongate article 1 is possible by feeding the elongate article 1 along its axis in the feed direction through a suitable opening arrangement 102, 104 of the clamping device 100, through an internal passage 106 connecting the openings 102, 104 of the opening arrangement. In the illustrated example, the opening arrangement comprises an entrance aperture 102 and an exit aperture 104 opposite the entrance aperture 102. The elongate article 1 cannot readily be inserted through the exit aperture 104 because this would be resisted by the clamp 200.

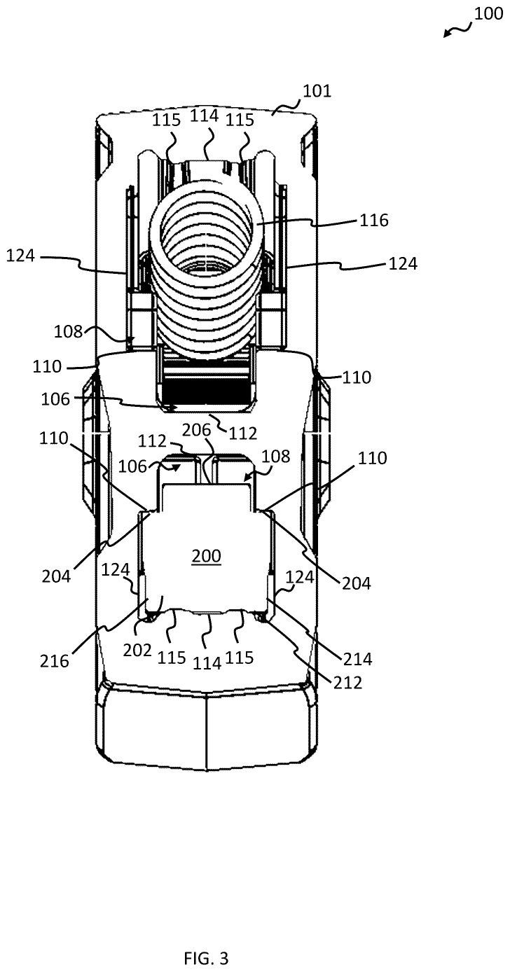

The shape of the internal space 108 of the clamping device 100 plays a role in enabling the clamp 200 to apply a force to the elongate article 1. As shown in FIGS. 2-3, the space 108 is bounded by first and second clamping formations in the form of a first clamping wall 112 and a second clamping wall 114, and is further bounded by side walls 124 (FIG. 3) connecting the first and second clamping walls 112, 114.

As shown in FIG. 2, the first clamping wall 112 may extend from the entrance aperture 102 to the exit aperture 104. The illustrated first clamping wall 112 may be a flat surface against which the side of the elongate article 1 can be compressed. Experiments found the flat surface to provide a slightly higher strength and less resistance to feeding of twisted wire, compared to a grooved first clamping wall 112 comprising a minor-diameter trough along which the barbed wire extends.

The second clamping wall 114 is a surface against which the clamp 200 can slide, as illustrated. The second clamping wall 114 tapers towards the first clamping wall 112 with increasing proximity to the entrance aperture 102. Therefore, the second clamping wall 114 acts as a ramp for the clamp 200.

The space 108 has a reducing cross-sectional area towards the entrance aperture 102, because the second clamping wall 114 tapers towards the first clamping wall 112. The spring 116 slides the clamp 200 along the second clamping wall 114, towards the entrance aperture 102, wedging the clamp 200 into the progressively narrowing gap between the first and second clamping walls 112, 114. This forces the clamping surface 206 of the clamp 200 against the side of the elongate article 1. The clamp 200 is wedged by the spring 116 between the second clamping wall 114 and the side of the elongate article 1. The elongate article 1 is wedged between the clamping surface 206 of the clamp 200 and the first clamping wall 112 of the clamping device 100.

In use, if the elongate article 1 is pulled in the feed direction, opposing the direction of the urging force (restoring force) of the spring 116, the clamp 200 is pushed out of the way of the passage 106 against the urging of the compressed spring 116. This enlarges the passage 106 along which the elongate article 1 can be drawn, and allows the elongate article 1 to exit through the exit aperture 104. The clamp 200 provides limited resistance to pulling the elongate article 1 in the feed direction.

When the elongate article 1 has been received through the clamping device 100, the clamping surface 206 of the clamp 200 engages the side of the elongate article 1 in the passage 106.

If the elongate article 1 is pulled in the reverse direction opposite the feed direction, this has the effect of pulling the clamp 200 with the elongate article 1 into the narrowing gap between the first and second clamping walls 112, 114, thereby tightly clamping the elongate article 1 and the clamp 200 between the first and second clamping walls 112, 114.

The clamping force is affected by the tapering angle of the tapering walls and the same convergence angle in which the clamp 200 is biased/movable relative to the passage 106 along which the elongate article 1 extends. The taper angle and the convergence angle have an oblique value. The oblique angle can be a value from the range 7-30 degrees, or more preferably from approximately 10 degrees to less than 20 degrees. Experiments found that values higher than 20 degrees had low join efficiency, and values lower than 10 degrees required high insertion force when inserting the elongate article. In an implementation, the sub-range is 10-15 degrees.

From FIG. 5 it can be seen that the serrations 218 on the clamp 200 may be sawtooth-shaped. The handedness of the sawtooth-shaped serrations provide more resistance to sliding of the elongate article 1 in the reverse direction than in the feed direction.

If it is desired to enable the elongate article 1 to be withdrawn from the clamping device 100 in the reverse direction, the user may insert a thin object through the entrance aperture 102 to push the clamp 200 and release the elongate article 1. Alternatively, a separate release aperture or button may be provided, adjacent the entrance aperture 102.

Referring to FIGS. 4-5, the clamp 200 can comprise an inwardly tapering portion 220 leading the clamping surface 206. The inwardly tapering portion 220 is wedge-shaped. The inwardly tapering portion 220 extends from the leading edge 222 of the clamping surface 206 to the leading end 210 of the clamp 200. In FIGS. 4-5, the leading edge 222 of the clamping surface 206 is defined as the apex of the leading serration 218A. This creates a tooth edge that can be embedded into the minor-diameter trough 1C of the elongate article 1.

The inwardly tapering portion 220 comprises a tapering surface 224 connected to the leading edge 222 of the clamping surface 206. The tapering surface 224 converges towards the sliding surface 212 with increasing distance from the leading edge 222 of the clamping surface 206, and is connected to the leading end 210 of the clamp 200. Therefore, the front of the clamp 200 is wedge-shaped, having a leading end 210 smaller than the trailing end 208.

The tapering surface 224 is non-serrated and therefore smoother than the clamping surface 206. The tapering surface 224 makes it easier to feed the elongate article 1 through the clamping device 100.

As the elongate article 1 is drawn through the clamping device 100 in the feed direction, sliding contact is made between the elongate article 1 and the tapering surface 224 of the clamp 200. The sliding contact pushes the clamp 200 back against the spring 116. This enables the elongate article 1 to be drawn in the feed direction with minimal resistance. However, if the elongate article 1 is slid in the reverse direction, the clamp 200 is pulled towards the side of the elongate article 1 (and pushed by the spring 116), causing the clamp 200 to become ‘wedged in’ between the elongate article 1 and the first clamping wall 112 of the housing 101 of the clamping device 100. This results in a biting force from the clamping surface 206 that increases the harder the elongate article 1 is pulled in the reverse direction.

The illustrated inwardly tapering portion 220 has a variable rate of tapering in the form of curvature. A curved tapering surface 206 aids insertion of the elongate article 1 by helping to guide the elongate article 1 along the tapering surface 206. Alternatively, a straight taper may be used.

An internal angle α (labelled in FIG. 5) between the tapering surface 224 of the clamp 200 and the plane defined by the clamping surface 206, measured at the leading edge 222 of the clamping surface 206, is an obtuse angle selected from the range 310-350 degrees (130-170-degree obtuse internal angle). It can be said that the leading edge 222 of the clamping surface 206 is V-shaped. Lower values of a within this range provide higher join efficiency, but values lower than 10 degrees may result in the leading edge 222 not fully embedding into the minor-diameter trough 1C of the elongate article 1.

As shown in FIG. 5, the clamping device 100 holds the clamp 200 at an oblique angle relative to the elongate article 1 so that the V-shaped leading edge 222 of the clamping surface fits into the V-shaped minor-diameter trough of the elongate article 1. The oblique angle facilitates contact between the clamping surface 206 and one of the strands 1B at a first side of the V-shaped minor-diameter trough 1C, and simultaneous contact between the tapering surface 224 and the other of the strands 1A at the other side of the V-shaped minor-diameter trough 1C.

In order to stably hold the clamp 200 at the oblique angle relative to the elongate article 1, and facilitate a smooth sliding/gliding motion to engage and release the clamp 200, the clamping device 100 comprises a track arrangement 110. The clamp 200 comprises a runner arrangement 204 to engage with the track arrangement 110. The track and runner arrangements 110, 204 ensure that the clamp 200 can only slide back and forth in a desirable direction.

The track arrangement 110 and runner arrangement 204 constrain the freedom of translation of the clamp 200 to a single degree of freedom of translation. Therefore, the clamp 200 can only move in a line. The track arrangement 110 may form a straight linear path which is parallel to the axis of the spring 116. The path may also be parallel to the second clamping wall 114. The path is at the required oblique angle relative to the elongate article 1.

As shown in FIG. 3, the illustrated track arrangement 110 can comprise a pair of tracks 110, and the runner arrangement 204 can comprise a pair of runners 204.

FIG. 3 shows a track 110 at each side wall 124 of the space 108, and a runner 204 at each side surface 214, 216 of the clamp 200.

More specifically, FIG. 3 illustrates each track 110 being a side ledge in the corresponding side wall 124 of the housing 101 of the clamping device 100, and each runner 204 being a step in the corresponding side surface 214, 216 of the clamp 200. The side ledges (tracks 110) are elevated at a constant height from the second clamping wall 114 and therefore extend towards the passage 106 at the oblique angle described earlier. The clamp 200 is trapped/captured between the second clamping wall 114 and the tracks 110. The clamp 200 is too wide to slip through the gap between the side ledges (tracks 110).

The clamp 200 can nonetheless slide along the tracks 110—that is, the steps in the side surfaces 214, 216 of the clamp 200 can slide along the side ledges in the side walls 124 of the internal space 108 of the housing 101.

The narrower clamping surface 206 of the clamp 200 may protrude beyond the tracks 110, and as such may be closer to the passage 106 than the tracks 110 and runners 204. This protrusion of the clamping surface 206 prevents the serrations 218 on the clamping surface 206 of the clamp 200 from binding on the housing 101 of the clamping device 100.

The illustrated runners 204 and tracks 110 are parallel to each other and extend in an approximately straight line. Therefore, the orientation of the clamp 200 cannot change as it moves along the tracks 110. The clamp 200 can be said to have zero degrees of rotational freedom.

The shapes of the tracks 110 and runners 204 are not limited to those shown. For example, a plug could slide along a socket. In further examples, more or different degrees of freedom may be provided.

The sliding surface 212 of the clamp 200 is slidable along the second clamping wall 114 as the clamp 200 is slid along the track arrangement 110. The sliding surface 212 of the clamp 200 remains in continuous contact with the second clamping wall 114 as the clamp 200 is slid along the track arrangement 110. The sliding surface 212 of the clamp 200 may remain in continuous contact with the second clamping wall 114 regardless of the position of the clamp 200 along the track arrangement 110.

The clamping surface 206 of the clamp 200 remains approximately parallel to the second clamping wall 114 and at the oblique angle relative to the first clamping wall 112 and elongate article 1, regardless of the position of the clamp 200 along the track arrangement 110. The sliding surface 212 of the clamp 200 remains approximately parallel to the second clamping wall 114 regardless of the position of the clamp 200 along the track arrangement 110.

FIG. 3 illustrates the second clamping wall 114 having a pair of parallel running ribs 115 such that the sliding surface 212 of the clamp 200 is in sliding contact with only the running ribs 115. This results in a small contact area. This enables the clamp 200 to be released more easily than if the area of contact was large. In other examples, the sliding surface 212 may comprise the running ribs 115. In further examples, the second clamping wall 114 may be without running ribs 114 but may be narrower than the sliding surface 212 of the clamp 200 to reduce the area of contact.

In an alternative implementation, there is no contact between the sliding surface 212 and the second clamping wall 114, and the clamp 200 is ‘suspended’ on the track arrangement 110 for at least some of its range of motion. In such an implementation, an appropriate name for the surface 212 would be ‘second surface’ rather than a sliding surface.

Referring now to the spring 116, the Figures illustrate the spring 116 being a coil spring. The coil spring is arranged as a compression spring, which is compressed as the clamp 200 slides along the track arrangement 110 away from the passage 106 for the elongate article 1. It will be appreciated that the spring 116 could be replaced by any other suitable type of spring.

The clamping device 100 comprises a spring seat 118 to which a base end of the spring 116 is seated. One end of the spring 116 is in contact with the trailing end 208 of the movable clamp 200, and the other (base) end of the spring 116 is in contact with the spring seat 118. Therefore, the spring 116 is compressed between the clamp 200 and the spring seat 118 as the clamp 200 is moved along the track arrangement 110 towards the spring seat 118. The spring seat 118 applies a reaction force as the spring 116 is compressed.

The illustrated spring seat 118 of the housing 101 extends partially across one end of the passage 106. The spring seat 118 may be a separate part that is secured to a spring seat opening in the housing 101 of the clamping device 100 after the spring 116 and clamp 200 have been inserted through the spring seat opening. The spring seat 118 does not fully close the spring seat opening, such that an aperture remains alongside the spring seat 118—this aperture is the exit aperture 104 for the elongate article 1.

The trailing end 208 of the clamp 200 is an approximately flat rear surface connecting the sliding surface to the clamping surface. The trailing end 208 (trailing end surface) is sufficiently flat to enable the spring 116 to be seated against the trailing end 208 of the clamp 200. The trailing end 208 illustrated in FIG. 5 is at approximately 95 degrees relative to the sliding surface 212, so that force from the spring 116 is slightly eccentric to help seat the spring 116 onto the clamp 200 and prevent buckling.

The trailing end 208 of the clamp 200 may further comprise a second, opposite spring seat 226 for the same spring 116. FIGS. 4 and 5 illustrate the clamp 200 having a protruding spring seat 226, protruding rearwardly from the trailing end 208 of the clamp 200 towards the opposite spring seat 118 of the housing 101. The spring seat 226 is located at the rear corner between the trailing end 208 and the clamping surface 206, and protrudes rearwardly. This optional spring seat 226 reduces the chance of the spring 116 slipping off the trailing end 208 of the clamp 200.

As shown in FIG. 2, the clamping device 100 may have two clamps 200. A second opening arrangement with a separate entrance aperture 102 and a separate exit aperture 104 enables a different elongate article 1 (or another portion of the same elongate article 1) to be clamped by the second, separate clamp 200 in a separate, partitioned internal space 108 of the housing 101 of the clamping device 100. This enables the clamping device 100 to secure two elongate articles end-to-end, such as two lengths of barbed wire.

An elongate partition 126 that separates the spaces 108 may define, at one of its sides, the first clamping wall 112 for the first clamp 200, and at its opposite side, the first clamping wall 112 for the second clamp 200. The partition 126 may be linear in shape.

Optionally, the feed direction associated with the second clamp 200 can be opposite the feed direction associated with the first clamp 200. Therefore, FIG. 2 illustrates the entrance aperture 102 of the second opening arrangement being adjacent to the exit aperture 104 of the first opening arrangement. Likewise, the exit aperture 104 of the second opening arrangement is adjacent to the entrance aperture 102 of the first opening arrangement.

In other implementations, the clamping device 100 may comprise only one clamp 200, or may comprise more than two clamps. As illustrated, the second clamp 200 may operate with the same principles as the first clamp 200, but does not necessarily have to be implemented in an identical manner to the first clamp 200. In further alternative embodiments, the second clamp 200 could have a different principle of operation, for example, the second clamp could be a crimping connector or other permanent/user-releasable connector.

Although embodiments of the present invention have been described in the preceding paragraphs with reference to various examples, it should be appreciated that modifications to the examples given can be made without departing from the scope of the invention as claimed. For example, instead of the clamping surface 206 being parallel to the sliding surface 212, the clamping device 100 may configured to slide and/or rotate a differently-shaped clamp 200 to embed a portion of the clamp in the minor-diameter trough 1C of the elongate article 1.

In a further alternative example, the elongate article 1 is another type of stranded wire, different from barbed wire.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A clamp for securing an elongate article within a clamping device, the clamp comprising:
an elongate clamp body having opposite ends;
a clamping surface on the clamp body; and
a sliding surface on the clamp body, wherein the clamping surface is substantially parallel to the sliding surface.

2. The clamp of claim 1, wherein the planes defined by the sliding surface and the clamping surface are substantially flat

3. (canceled)

4. The clamp of claim 1, wherein the opposite ends are leading and trailing ends, wherein the clamp body is shaped such that the leading end of the clamp body leads a leading edge of the clamping surface of the clamp body.

5. The clamp of claim 4, wherein the clamp body further comprises an inwardly tapering portion, separate from the substantially parallel sliding surface and clamping surface, and wherein the inwardly tapering portion extends from the leading edge of the clamping surface to the leading end of the clamp body.

6. The clamp of claim 5, wherein the inwardly tapering portion extends from a first serration defining the leading edge of the clamping surface, to the leading end of the clamp body.

7. The clamp of claim 5, wherein an internal angle between the inwardly tapering portion of the clamp and a plane defined by the clamping surface of the clamp, measured at the leading edge of the clamping surface, is an obtuse angle.

8. The clamp of claim 1, wherein the clamping surface of the clamp is serrated.

9. (canceled)

10. The clamp of claim 8, wherein depths of the serrations vary along the clamping surface.

11. The clamp of claim 1, wherein the elongate article is barbed wire and the clamping surface is slidable into a trough defining a minor diameter of the barbed wire.

12. A clamping device comprising:
a housing comprising apertures to allow the elongate article to extend through a passage within a space in the housing of the clamping device; and
the clamp as claimed in claim 1.

13. The clamping device of claim 12, wherein the housing of the clamping device comprises a first clamping formation against which the clamp is configured to clamp the elongate article, wherein the clamp is movable in the housing to a clamping position in which the clamp wedges the elongate article against the first clamping formation of the housing of the clamping device, at an angle in which the clamping surface of the clamp body is at an oblique angle relative to the first clamping formation of the housing.

14. The clamping device of claim 13, wherein the first clamping formation is a first clamping wall, wherein the housing of the clamping device comprises a second clamping wall configured to apply a clamping force to the clamp, so that the clamp and the elongate article are clamped between the first and second clamping walls, wherein the first and second clamping walls converge towards each other, and wherein the first and second clamping walls provide a narrowing gap therebetween.

15. The clamping device of claim 14, wherein the clamping surface of the clamp body is parallel to the second clamping wall.

16. The clamping device of claim 14, wherein the sliding surface of the clamp body is parallel to the second clamping wall, and wherein the sliding surface of the clamp body is configured to slide along the second clamping wall.

17. The clamping device of claim 13, wherein the oblique angle is a value selected from the range 7 degrees to less than 30 degrees.

18. The clamping device of claim 13, comprising a spring configured to urge the clamp into clamping engagement with the elongate article.

19. (canceled)

20. The clamping device of claim 13, wherein the apertures of the housing of the clamping device are opposite apertures.

21. (canceled)

22. The clamping device of claim 13, wherein the housing comprises separate apertures to allow a different elongate article or another portion of the elongate article to extend through a second passage within a second space in the housing of the clamping device, to be clamped by a second one of the clamp, wherein the housing comprises a further first clamping formation against which the second clamp is configured to clamp the different elongate article or different portion of the elongate article, wherein the second clamp is movable in the housing to a clamping position in which the second clamp wedges the different elongate article or different portion of the elongate article against the further first clamping formation of the housing of the clamping device, at an angle in which the clamping surface of the clamp body of the second clamp is at an oblique angle relative to the further first clamping formation of the housing.

23. (canceled)

24. (canceled)

25. A clamping device comprising:
a housing comprising apertures to allow an elongate article to extend through a passage within a space in the housing of the clamping device; and
a clamp comprising an elongate clamp body having opposite ends, and a clamping surface on the clamp body,
wherein the housing of the clamping device comprises a first clamping formation against which the clamp is configured to clamp the elongate article,
wherein the clamp is movable in the housing to a clamping position in which the clamp wedges the elongate article against the first clamping formation of the housing of the clamping device, at an angle in which the clamping surface of the clamp body is at an oblique angle relative to the first clamping formation of the housing.

26. The clamp of claim 1, wherein the clamping surface of the clamping body is serrated, wherein apexes of the serrations define a plane which is substantially parallel to a plane of the sliding surface, wherein the clamp further comprises an inwardly tapering portion on the clamp body, separate from the substantially parallel sliding surface and clamping surface, and wherein the inwardly tapering portion comprises a tapering surface connected to a leading edge of the clamping surface.
